(19) United States
(12) Patent Application Publication
(10) Pub. No.: US 2026/0021914 A1
(43) Pub. Date: Jan. 22, 2026

(54) UAV Docking Station

(71) Applicant: Nick REYNTJENS, Bankso (BG)

(72) Inventor: Nick REYNTJENS, Bankso (BG)

(21) Appl. No.: 18/928,040

(22) Filed: Oct. 27, 2024

(30) Foreign Application Priority Data
Jul. 19, 2024 (PT) 20242006315093

(51) Int. Cl. B64U 80/25; B64U 10/14; B64U 70/99

(52) U.S. Cl. CPC B64U 80/25; B64U 10/14; B64U 70/99

(57) ABSTRACT

This invention discloses a docking station for unmanned aerial vehicles (UAVs) that enables automated docking, charging, and protection from environmental elements. An enclosure provides shelter against weather conditions and physical interference. The docking station facilitates efficient UAV operation by automating the landing, charging, and safeguarding processes, thereby increasing operational availability and reducing downtime. This system is adaptable to various UAV sizes and types, offering a versatile solution for diverse applications.

### TECHNICAL FIELD

This invention relates to unmanned aerial vehicles (UAVs), and more particularly to docking stations for UAVs, enabling automated docking, charging, and protection from the elements.

### BACKGROUND OF THE INVENTION

Unmanned Aerial Vehicles (UAVs) are rapidly transforming industries like surveillance, delivery, agriculture, and inspection. To maximize their potential, UAVs are increasingly required to operate autonomously over extended periods and across wider areas. However, current UAV deployments face a significant hurdle: the limited capacity of onboard batteries. This constraint necessitates frequent recharging, often requiring manual intervention and disrupting workflows.

Existing solutions for UAV recharging present several drawbacks. Manual battery swaps are time-consuming and labor-intensive, hindering the efficiency of autonomous operations. While some automated docking stations exist, they often rely on complex landing procedures, vulnerable to wind gusts and ground effects that make precise landings challenging. Furthermore, many current docking stations utilize cumbersome enclosures with actuators, adding complexity and potential points of failure.

There exists a clear need for a UAV docking station that enables reliable, automated docking and charging while simplifying the landing process and enhancing protection from the elements.

### SUMMARY OF THE INVENTION

This invention provides a UAV docking station that overcomes the limitations of existing recharging solutions by enabling automated docking, charging, and environmental protection in a simplified and reliable manner. The docking station employs a novel guidance mechanism that utilizes the UAV's propeller guards and the station's surfaces to securely guide the UAV into the docking position. This eliminates the need for precise landing maneuvers and complex sensors, enhancing reliability and ease of use.

This invention offers a more versatile approach to docking. While it primarily encourages an ascending trajectory for increased stability by avoiding ground effect, it can also accommodate a traditional descending approach. A descending approach might be preferable in specific situations, such as when the docking station is located on a structure designed to minimize downward wind currents, like a platform with wind holes. However, ascending docking remains the preferred method due to its inherent stability advantages.

Furthermore, the docking station incorporates a self-cleaning electrical contact mechanism for efficient charging and relies on a minimal set of sensors, ideally only GPS, for docking. This minimalist design reduces complexity and potential points of failure.

By combining simplified docking with robust charging and protection features, this invention offers a practical and efficient solution for autonomous UAV operation, particularly in applications requiring extended flight durations and minimal human intervention.

### BRIEF DESCRIPTION OF THE DRAWINGS

FIGS. 1 and 2 show one embodiment as a structure on a pole.

FIG. 1 shows one embodiment as a structure on a pole.

FIG. 2 shows one embodiment as a structure on a pole.

FIGS. 3 show one embodiment of a possible securing and charging assembly.

FIGS. 4 show one embodiment of a possible securing and charging assembly.

FIGS. 5 show one embodiment of a possible UAV mating structure secured to a uav.

FIG. 6A shows the main docking movements of the uav.

FIG. 6B shows the main docking movements of the uav.

FIG. 7 shows the main docking movements of the uav.

FIGS. 8A and 8B show the movement that causes the uav to separate from the docking station; small movements in this direction may clean the electrical contacts.

FIG. 9 can be omitted and hold no information for this application.

FIG. 10 shows a sideways cross section of a uav docking in an ascending manner, in a conic like structure

FIG. 11 shows a sideways cross section of a uav docking in a descending manner, a conic like structure, the docking station mating assembly can possibly be attached onto a grill (represented by a dashed line) like structure to avoid ground effect. Any wind permeable structure will be preferred.

### DETAILED DESCRIPTION OF THE INVENTION

Specific features, structures, or characteristics mentioned in reference to a particular embodiment may or may not be present in other embodiments. The use of terms such as “one embodiment,” “an embodiment,” or “an illustrative embodiment” does not imply limitations or exclusivity. Additionally, references to “preferred” components or features signify their desirability in specific contexts but do not restrict their applicability to other embodiments.

It is understood that a person skilled in the art, upon reviewing this disclosure, can readily implement described features, structures, or characteristics in connection with other embodiments, whether explicitly described or not.

Listings in the form of “at least one of A, B, and C” encompass all possible combinations of A, B, and C, including individual elements and their conjunctions. The same principle applies to listings in the form of “at least one of A, B, or C” and “A, B, and/or C.” In the claims, terms like “a,” “an,” “at least one,” and “at least one portion” are not limiting to a single element unless explicitly stated.

While the drawings illustrate specific arrangements and orderings of structural or method features, these are not prescriptive. In various embodiments, such features may be arranged differently or combined, unless otherwise specified. The inclusion of a feature in a particular figure does not imply its necessity in all embodiments.

The disclosed embodiments can be implemented in hardware, firmware, software, or any combination thereof. They can also be embodied as instructions stored on machine-readable media, executed by one or more processors.

In one possible embodiment, the docking procedure employed by this invention can utilize a novel guided approach. The UAV, equipped with propeller guards, may leverage these guards to make controlled contact with the first surface of the docking station. This initial contact may serve to decelerate the UAV and position it for the subsequent alignment phase. Next, the UAV may then maneuver laterally towards the second surface while maintaining contact with the first surface, which can guide the UAV into the docking space defined by the angular intersection of the two surfaces. Once securely positioned within this space, the UAV may initiate a vertical ascent. This ascent may culminate in the engagement of the UAV's mating structure with the complementary mating structure on the docking station. This engagement, possibly aided by magnetic elements for self-alignment, may establish a secure connection and facilitate the subsequent charging process. This approach can effectively simplify the docking maneuver, reduce reliance on complex sensors, and enhance overall reliability.

The UAV docking station may optionally comprise:
A first surface: This surface is configured to receive a UAV and engage with the UAV's propeller guards. It can be a wall of a structure or a panel secured to a wall, or a panel mounted on a free standing construction, possibly mounted on a pole.
A second surface: This surface is disposed at an angle relative to the first surface, typically 90 degrees. It is also configured to receive the UAV and engage with its propeller guards after the UAV has made contact with the first surface. Like the first surface, it can be a wall or a panel secured to a wall, or a panel mounted on a free standing construction, possibly mounted on a pole.
Docking space: The first and second surfaces cooperate to define a docking space configured to securely retain the UAV within the angle formed by the surfaces.
Mating structure: Positioned above the docking space, this structure is configured to engage with a complementary mating structure on the UAV. This engagement occurs after the UAV has been secured within the docking space and ascends vertically.
Securing mechanism: A mechanism for securing the mating structure of the UAV to the mating structure of the docking station. This mechanism may utilize magnetic elements, such as permanent magnets, electromagnets, or magnetically attractable metal components, or any other suitable means for achieving a secure connection.
Means for transmitting electrical power: This may include electrical connectors with positive and negative contacts, wireless power transmission systems, or any other suitable technology for transferring electrical energy between the docking station and the UAV for battery charging.
Actuator: An actuator is coupled to the securing mechanism on the docking station's mating structure. This actuator is configured to release the securing mechanism to facilitate disengagement of the mating structures, initiating the undocking process.
Separation mechanism: This mechanism aids in separating the engaged mating structures when the actuator is activated. The first and second surfaces halt the UAV's movement by engaging its propeller guards, ensuring a clean separation.
Cleaning mechanism: This mechanism (optional) is configured to clean the electrical contacts or other components involved in power transmission. In the example embodiment, the separation actuator also performs the cleaning action.
Enclosure: The docking station may further include a third and fourth surface, along with a roof, to form an enclosure that protects the UAV from environmental conditions.
Radio-frequency transparent material: At least one of the surfaces, including an optional roof, may be made from a radio-frequency transparent material to allow unimpeded reception of GNSS signals within the docking station.
Communication Interface: A means of communicating with the UAV, enabling the docking station and the UAV to exchange information directly or indirectly, wirelessly or partially wired, to synchronize docking and undocking operations. This interface facilitates coordinated actions and data transfer between the UAV and the docking station.

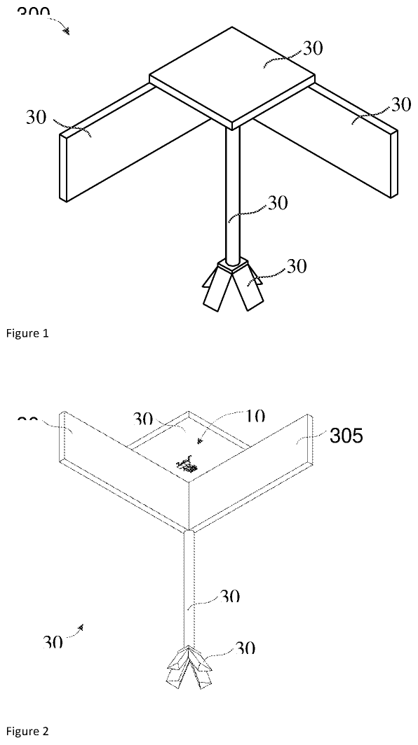

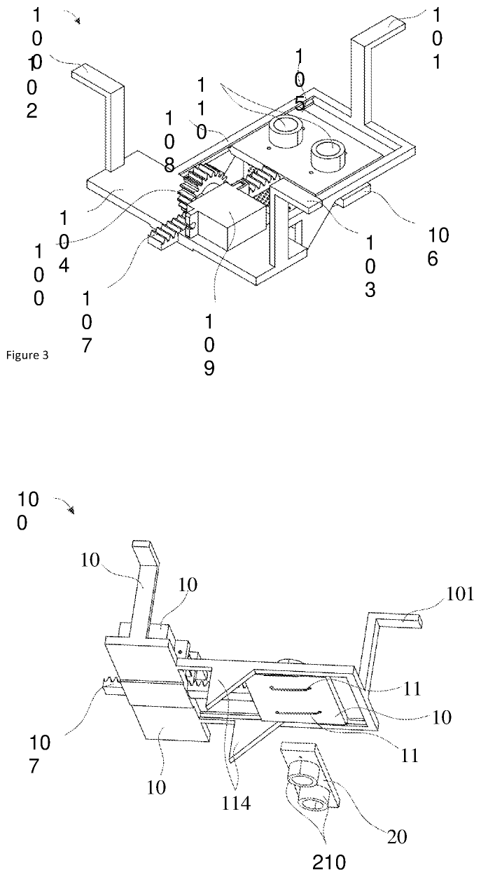

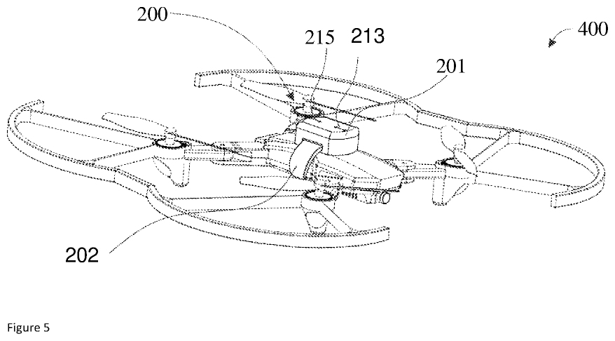

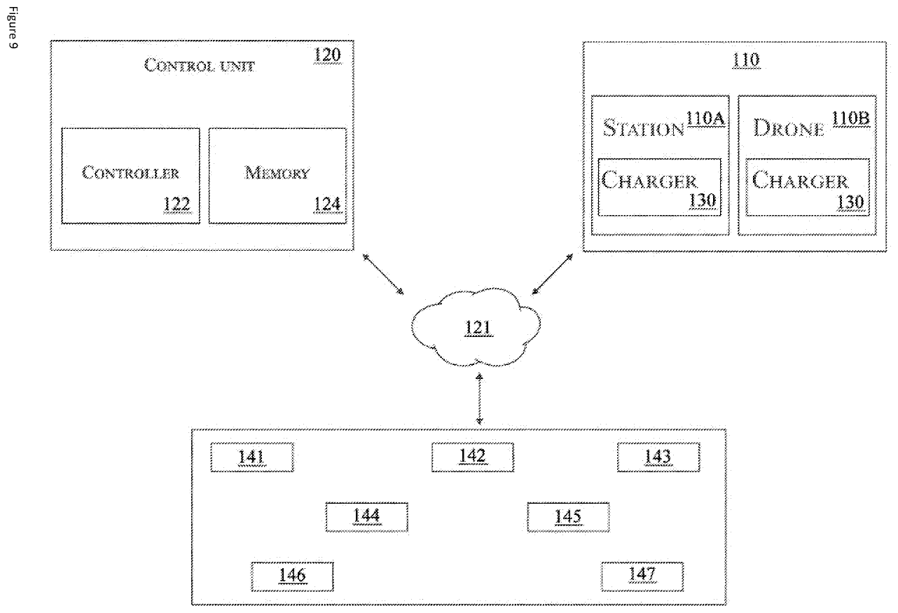

In one embodiment, exemplified in FIGS. 1 to 11, a UAV docking station (300) comprises a first surface (305) and a second surface (306) configured to engage with the UAV's (200) propeller guards and define a docking space. At least one of these surfaces, and an optional roof surface (304), may comprise a radio-frequency transparent material to allow for GNSS signal reception. The first surface (305) may be secured to a first wall of a structure and the second surface (306) to a second wall. The docking station may further include a third and fourth surface to form an enclosure that protects the UAV (200) from environmental conditions. A mating structure (105) part of a securing and charging assembly (100), on the docking station, positioned above the docking space, is configured to engage with a complementary mating structure (201) on the UAV (400). The mating structure on the uav (201), may comprise of element (206) having magnetic pockets (210). FIG. 4 shows element (206), that is a part of part (201), in isolation, to exemplify how to magnetically mate with structure (105), that may also include magnetic elements, to be held in place by magnet pockets (110) facilitating self-alignment and secure engagement of the mating elements.

An actuator (109) may be coupled to the magnetic element holder (110) to facilitate disengagement of the mating structures (105, 201), and a separation feature (114) may further assist in this process. The docking station may also include means for transmitting electrical power to the UAV (200) for charging its battery. If the means (113, 115, 213, 215) for transmitting electrical power comprise electrical contacts, a cleaning mechanism may be employed to remove debris and oxidation from the contacts.

A multicopter UAV may maintain contact with docking station surfaces by navigating towards them using sensors and GPS. It could then adjust its pitch to gently push itself towards the first surface, using propeller guards or any means to ensure propeller clearance. By constantly adjusting pitch and roll, aided by smooth surfaces and vibrations, the UAV could slide along the first surface and then towards the second. This controlled manipulation of angles, inherent in navigating to a GPS coordinate, may enable precise maneuvering and contact for actions like charging.

The elements shown in the figures can be further described as follows. The docking station assembly (300) includes a roof panel (304) constructed from a radio-frequency transparent material, allowing for unobstructed GPS signal reception. The first guide panel (305) initiates the docking sequence when the UAV (400) intentionally makes contact with it using its propeller guards. After initially engaging with the first guide panel (305), the UAV (400) maneuvers to contact the second guide panel (306), refining its alignment within the docking space. A support pole (301) provides structural support for the docking station assembly (300), and support pole standing legs (302) ensure the stability of the overall structure. The securing and charging assembly (100) is mounted to the underside of the roof panel (304) using mounting brackets (101, 102, 103) and houses the mechanisms for securing, charging, and releasing the UAV (400). A base plate (104) serves as the foundation for the securing and charging assembly (100) and features linear guide grooves (108) that guide the movement of the mating structure (105). A servo motor (109) controls the movement of the geared rack (107), which drives the docking station mating structure (105) for both docking/undocking and cleaning actions. The geared rack (107) translates the rotational motion of the servo motor (109) into linear motion. The docking station mating structure (105) houses the magnet holding pockets (110) and a positive (113) and negative contact point (115), collectively referred to as electrical connector. It engages with the uav mating structure (201) to secure the UAV (400) and establish electrical contact for charging. The magnet holding pockets (110) securely hold the magnets that facilitate self-alignment and engagement with the uav mating structure (201). The first electrical connector (112) provides the electrical interface for charging the UAV's battery. A slight movement of the mating structure (105), actuated by the servo motor (109), enables a cleaning action by rubbing the contacts against those on the uav mating structure (201). The forced uav unmating structure (114) aids in separating the mating structures (105, 201) during the undocking process. The UAV (200) has an attached uav mating structure assembly (201). The uav mating structure (201) houses part (206) which houses magnet holding pockets (210) and positive (213) and negative contact point (215), which mates with the corresponding electrical contacts (113 and 115) components on the docking station mating structure (105). In some embodiments the contact points may be a simple copper wire. The magnet holding pockets (210) hold the magnets that attract those on the docking station mating structure (105), aiding in self-alignment and secure engagement. An optional strap (202) provides an additional, non-permanent method for securing the uav mating structure (201), part of a bigger assembly (200), to the UAV (400). Other embodiments may have the uav mating structure (201) embedded or fixed to the drones body in a more permanent way.

This docking station enables several methods of docking and charging a UAV (400). The UAV (400) can be directed towards the first surface (305) using its propeller guards, maneuvered towards the second surface (306), and ascended to engage the mating structures (105, 201). This process may involve activating a cleaning mechanism if electrical contacts are used for power transmission. Alternatively, the UAV (200) can be navigated using onboard GPS to specific target points to achieve docking and charging. In the case of an enclosure, the UAV (200) may first be directed into the enclosure before proceeding with either the contact-based or GPS-guided docking procedure. A system for docking a UAV (400) may include a controller that can navigate the UAV (400) to the docking station (300), maneuver it within the docking space, engage the mating structures (105, 201), activate a cleaning mechanism, and initiate charging.

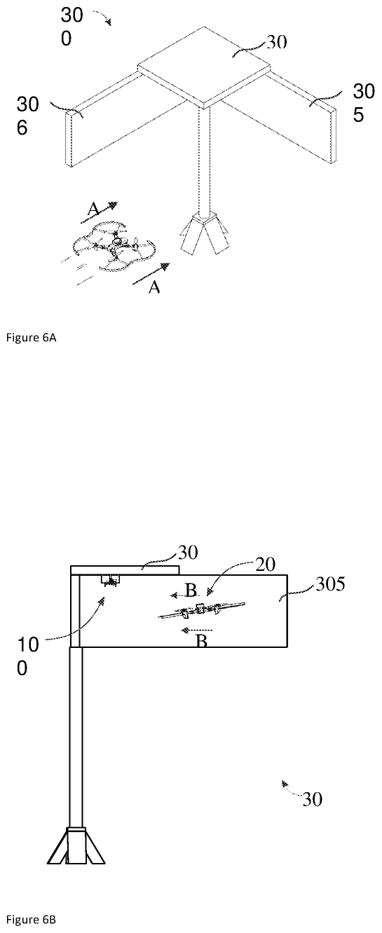

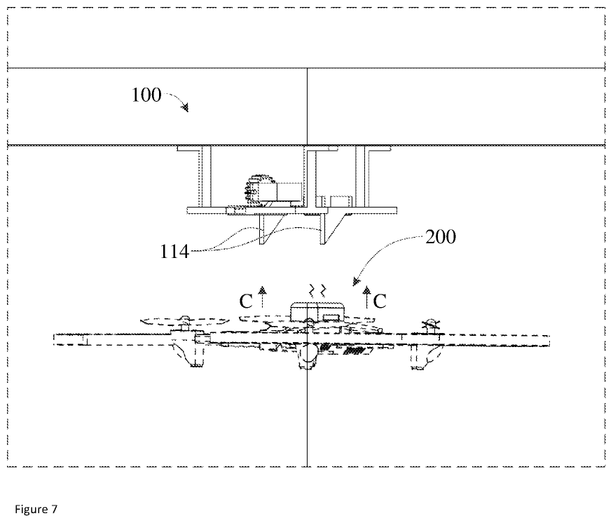

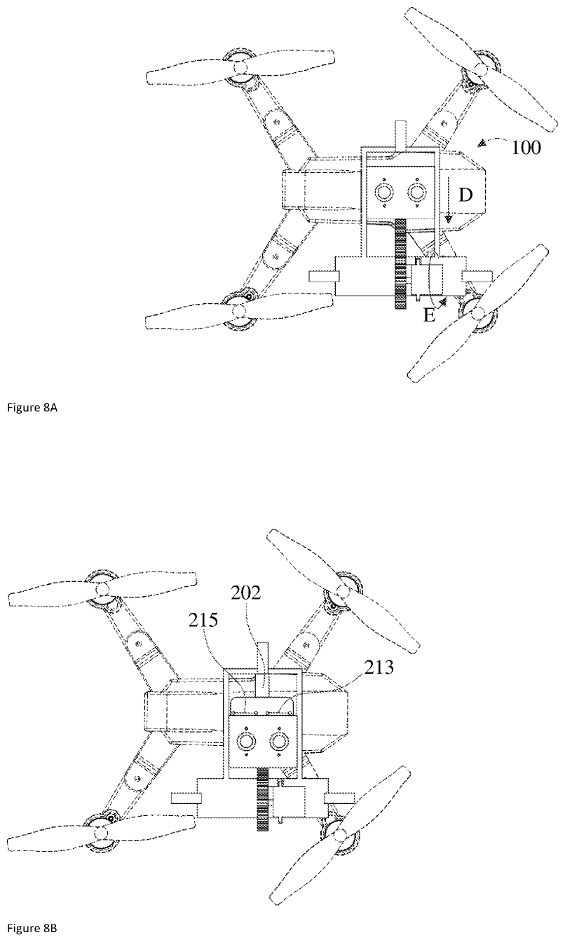

A UAV may dock by first making contact with the first surface and pushing its propeller guards against it, an example is shown in FIG. 6A, movement A. It then moves towards the second surface while maintaining contact with the first surface, an example is shown in FIG. 6B, movement B. Upon reaching the second surface, the UAV pushes its propeller guards against it, securing itself within the docking space. The UAV then ascends vertically while remaining in the same horizontal location, guided by both surfaces, until its top-mounted mating structure engages with the docking station's mating structure, an example is shown in FIG. 7, movement C. The magnetic elements assist in this engagement. Once docked, the electrical connectors mate, and the UAV's battery is charged. To undock, the actuator displaces the magnetic element, separating the mating structures. The separation mechanism aids in this process, and the UAV descends from the docking station. The UAV docking station, in its basic form, comprises a first surface and a second surface positioned at an angle to each other, typically 90 degrees. These surfaces, which can be walls of a structure or panels secured to walls, serve to guide and secure the UAV during the docking process. Optionally, a third and fourth surface can be added to create a complete enclosure, protecting the UAV from the elements and leaving only an opening at the bottom for entry and exit. The docking movements can be performed entirely based on GPS, keeping the required sensors to a minimum.

### Docking Procedure (2 side panels)

1. The UAV begins the docking process by using its onboard GPS to navigate to a target point positioned slightly beyond the first guide panel (305). This intentional overshoot ensures that the UAV makes firm contact with the panel using its propeller guards, establishing a stable starting point for the docking maneuver.
2. Next, the UAV receives a new GPS target located slightly behind the intersection of the first and second guide panels (305 and 306). This target is ideally positioned on the mid-plane between the two panels and at the same altitude as the initial target point. By navigating to this second target, the UAV maintains contact with the first panel while simultaneously engaging with the second panel, effectively securing itself within the docking space.
3. With the UAV securely held within the docking space, a third GPS target is defined. This target shares the same latitude and longitude as the second target but has an altitude slightly above the top of the docking station's mating structure (105, 113). The UAV ascends vertically towards this target, guided by the two panels, until its own mating structure (201) makes contact with the corresponding mating structure on the docking station. The magnets within these mating structures aid in self-alignment and ensure a secure connection.
4. Optionally, before charging begins, the separation actuator (109) may be activated to move the docking station's mating structure slightly forward and backward. This movement causes the electrical contacts on both mating structures to rub against each other, cleaning away any debris or oxidation and ensuring a reliable connection for charging.
5. Once this connection is established, the electrical connectors mate, and the UAV's battery begins charging automatically.

### Docking Procedure with Enclosure (4 panels)

In the case of a four-panel enclosure, the following steps are added to the beginning of the docking procedure:
1. The UAV must first navigate to a GPS target positioned horizontally at the center of the four side panels and vertically below the bottom edge of the panels.
2. Once the UAV reaches this position, it ascends vertically to a new GPS target located at the same horizontal position but with an altitude that places the UAV inside the enclosure, clear of the side panels.

From this point onward, the UAV follows the standard docking procedure outlined for the two-panel version, starting with step 3 (ascending to engage with the mating structure).

When the uav is a multicopter, then horizontal movement is accomplice by changing the pitch or roll angles of the vehicle. To keep contact with said first surface, the uav can keep a constant slight pitch or roll, resulting in a constant force being exerted against the surface.

The UAV docking station achieves high reliability through the synergistic combination of several key features. The guided docking procedure, facilitated by the first and second surfaces, simplifies the docking maneuver and minimizes reliance on complex sensors, thereby reducing potential points of failure. These surfaces also act as wind shields, creating a protected environment within the docking space and mitigating the destabilizing effects of wind gusts during the docking process. Furthermore, the magnetic elements incorporated into the mating structures provide self-alignment capabilities, ensuring accurate and secure engagement even with minor positional variations. This robust docking solution offers numerous advantages, including simplified and automated docking, eliminating the need for complex landing maneuvers. The use of propeller guards and multiple surfaces ensures a secure and stable docking connection, while the optional enclosure provides additional protection from environmental elements, further enhancing reliability. Efficient and automated battery charging is enabled by the integrated electrical connectors. Moreover, the use of radio-frequency transparent material ensures reliable GNSS signal reception within the docking station, facilitating easy docking and undocking maneuvers. This combination of features ensures consistent and dependable operation of the UAV docking station, even in challenging conditions.

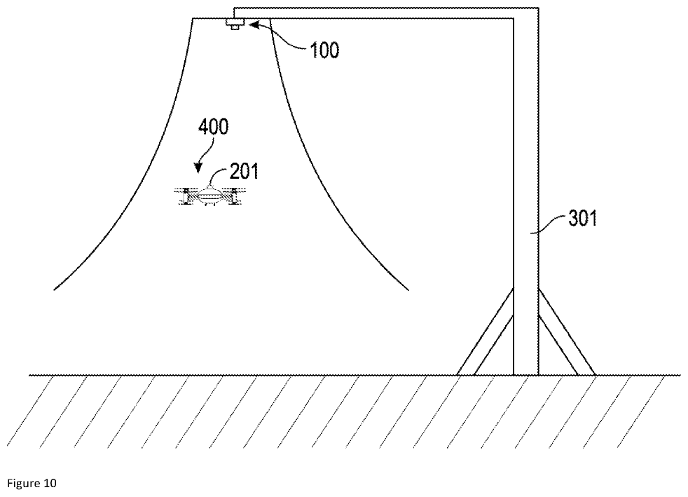

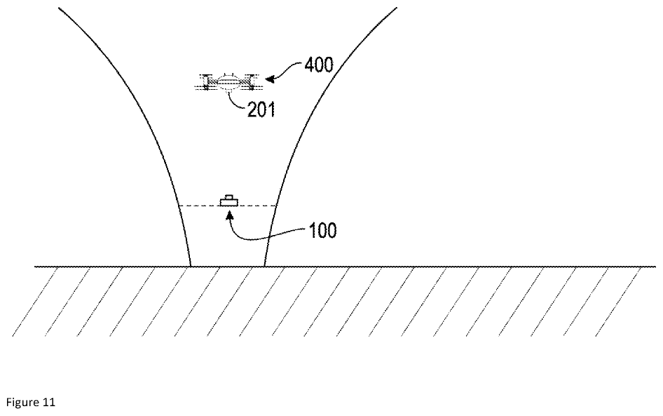

Some embodiments of this invention center around an innovative guidance mechanism that utilizes the UAV's existing propeller guards to simplify the docking process. In this context, “propeller guards” refer to any structural element on the UAV designed to prevent the propellers from coming into contact with the surrounding environment, including traditional propeller cages, extended arms, or any other feature that creates a physical buffer zone around the propellers. By incorporating specifically designed surfaces on the docking station, a reliable and self-aligning system is created. As the UAV approaches, its propeller guards make contact with these guiding surfaces, passively steering it into the correct docking position. This eliminates the need for complex sensors or precise maneuvering, increasing the robustness of the docking procedure. While a 90-degree corner provides an effective guiding structure, a conic design offers a compelling alternative with a wider entry point for easier initial approach and a gradual “funneling” effect for enhanced precision. The conic structure also accommodates both ascending and descending approaches, offering flexibility for different scenarios, and its aerodynamic shape can be optimized to minimize wind resistance. Ultimately, the choice between these guiding structures depends on the specific needs of the UAV and its operating environment. Example embodiment of conic guiding surface are shown in images FIGS. 10 and 11. Some embodiments may only use the mating mechanism that has been disclosed, and use another guidance system or none.

For the purposes of this disclosure, the term “conical surface” is intended to encompass a broad range of three-dimensional guide structures, including classic cones with a curved surface extending from a circular base to a point, exhibiting a continuous taper; pyramids, which are polygonal-based structures with triangular faces that converge at an apex; conical frustums, defined as the portion of a cone or pyramid remaining after a section parallel to the base is removed; and hybrid structures, encompassing any guide structure exhibiting characteristics of a cone, pyramid, or conical frustum, including those with blended features or modified shapes, such as a cone with a truncated or chamfered top, or a pyramid with curved edges. This inclusive definition of “conical surface” allows for flexibility in the design and implementation of the UAV docking station, accommodating various geometries that achieve the desired guiding function. It is important to note that this definition is not limited to mathematically perfect cones or pyramids, but extends to any structure that approximates this converging form and effectively guides the UAV into the docking station.

The UAV may communicate with the docking station indirectly via a 5G connection to the cloud. This connection could allow the UAV to check the docking station's status remotely, which may include its availability and any potential issues. Furthermore, a sophisticated algorithm residing in the cloud could act as a central command center, potentially directing the actions of the UAV and coordinating the activities of an entire swarm of UAVs. This cloud-based control system may enable efficient task allocation, optimized flight paths, and real-time adaptation to changing conditions, potentially enhancing the overall effectiveness and flexibility of the UAV operation.

1. A UAV docking station comprising a guide structure configured to receive a UAV and engage with the UAV's propeller guards, wherein said guide structure is selected from the group consisting of:
a first surface and a second surface, disposed at an angle relative to said first surface, wherein the second surface is configured to engage with the UAV's propeller guards upon the UAV moving towards said second surface while maintaining engagement with said first surface, and wherein said first and second surfaces cooperate to define a docking space configured to securely retain said UAV within said angle;
a conical surface having a wide opening at a first end and narrowing towards a second end, said second end being disposed above said first end; and
other structures configured to guide the UAV towards a mating structure;
a mating structure positioned to engage with a complementary mating structure on said UAV upon said UAV moving towards said mating structure while maintaining engagement with said guide structure.

2. The UAV docking station of claim 1 comprising said mating structure is positioned above said docking space and configured to engage with a complementary mating structure on said UAV upon said UAV ascending from said docking space while maintaining engagement with said first and second surfaces.

3. The UAV docking station of claim 2, wherein at least one of said surfaces or an optional roof surface comprises a radio-frequency transparent material, said radio-frequency transparent material being selected to facilitate unimpeded reception of global navigation satellite system (GNSS) signals within said docking station.

4. The UAV docking station of claim 1, wherein said first surface is secured to a first wall of a structure and said second surface is secured to a second wall of said structure.

5. The UAV docking station of claim 1, further comprising:
A third surface and a fourth surface configured to cooperate with said first surface, said second surface, and said roof to define an enclosure;
Wherein said enclosure is configured to protect said UAV from environmental conditions.

6. The UAV docking station of claim 1, wherein:
Said mating structure on said docking station further comprises a first magnetic element selected from the group consisting of a permanent magnet, an electromagnet and a magnetically attractable metal component; and
Said complementary mating structure on said UAV further comprises a second magnetic element selected from the group consisting of a permanent magnet, an electromagnet and a magnetically attractable metal component,
Wherein said first magnetic element and said second magnetic element are configured to magnetically attract each other when said mating structure and said complementary mating structure come within a predetermined range, thereby facilitating self-alignment and engagement of said mating structure and said complementary mating structure.

7. The UAV docking station of claim 6, wherein said docking station further comprises an actuator coupled to said first magnetic element, said actuator configured to displace said first magnetic element to facilitate disengagement of said mating structure and said complementary mating structure.

8. The UAV docking station of claim 7, wherein:
Said first surface and said second surface are configured to halt movement of said UAV by engaging said propeller guards; and
Actuation of said actuator to displace said first magnetic element effects separation of said mating structure and said complementary mating structure, thereby allowing said UAV to depart from said docking station.

9. The UAV docking station of claim 8, further comprising a separation mechanism configured to urge said mating structure and said complementary mating structure apart upon actuation of said actuator.

10. The UAV docking station of claim 1, further comprising:
A first electrical connector comprising a first positive contact and a first negative contact, wherein said first electrical connector is integrated with said mating structure on said docking station; and
A second electrical connector comprising a second positive contact and a second negative contact, wherein said second electrical connector is integrated with said complementary mating structure on said UAV;
Wherein, upon engagement of said mating structure and said complementary mating structure:
Said first positive contact and said second positive contact are configured to electrically connect;
Said first negative contact and said second negative contact are configured to electrically connect; and
Electrical energy is transferred between said docking station and said UAV via said connected contacts to facilitate charging of a battery within said UAV.

11. The UAV docking station of claim 10, further comprising a cleaning mechanism configured to: * Move said first electrical connector relative to said second electrical connector; and * Effect rubbing contact between said first positive contact and said second positive contact and between said first negative contact and said second negative contact, * Wherein said rubbing contact is configured to remove debris and oxidation from said contacts to ensure a reliable electrical connection.

12. A method of docking a UAV with a docking station and charging the UAV, the method comprising:
directing the UAV towards a first surface of the docking station to make contact with the first surface using propeller guards of the UAV;
maneuvering the UAV towards a second surface of the docking station while maintaining contact with the first surface, wherein the second surface is disposed at an angle relative to the first surface;
ascending the UAV while maintaining contact with the first and second surfaces to engage a mating structure of the UAV with a complementary mating structure of the docking station; and
charging a battery of the UAV via the means for transmitting electrical power.

13. The method of claim 11, wherein the means for transmitting electrical power comprise electrical contacts, the method further comprising activating a cleaning mechanism to clean the electrical contacts.

14. The method of claim 12, further comprising directing the UAV into an enclosure prior to contacting the first surface.

15. The method of claim 12, further comprising navigating the UAV using onboard GPS to a sequence of target points to achieve docking with the docking station, wherein the sequence of target points comprises:
a first target point positioned beyond the first surface;
a second target point positioned behind an intersection of the first and second surfaces; and
a third target point positioned above the mating structure.

16. The UAV docking station of claim 1, further comprising:
a pole; and
a pole stand coupled to said pole, wherein said first and second surfaces are mounted on said pole, whereby the docking station can be positioned independent of existing structures.

17. A method of controlling a multicopter UAV for docking, comprising deliberately adjusting an angle of the UAV to bring the UAV into contact with a vertical, planar surface of a docking station and maintain the contact with the surface to achieve a desired relative position.

18. The method of claim 17, further comprising:
adjusting a first angle of the UAV selected from a group consisting of a pitch angle and a roll angle to bring the UAV into contact with a first surface of the docking station; and;
adjusting at least one of a pitch angle and a roll angle of the UAV to maintain contact with the first surface while moving towards a second surface of the docking station.

19. The method of claim 18, further comprising:
performing a vertical movement after reaching a space between the first surface and the second surface to mate a mating structure of the UAV with a complementary mating structure of the docking station.
charging a battery of the UAV via at least one of electrical contacts disposed on at least one of the mating structures and wireless power transfer.

20. The method of claim 19, wherein charging the battery of the UAV via electrical contacts further comprises activating a cleaning mechanism to clean the electrical contacts prior to charging the battery.
